(19) United States
(12) Patent Application Publication
(10) Pub. No.: US 2013/0279729 A1
(43) Pub. Date: Oct. 24, 2013

(54) Waterproof Speakers and Audio System

(71) Applicant: Keith Richards, Lawndale, CA (US)

(72) Inventor: Keith Richards, Lawndale, CA (US)

(21) Appl. No.: 13/918,730

(22) Filed: Jun. 14, 2013

Related U.S. Application Data
(63) Continuation-in-part of application No. 12/883,099, filed on Sep. 15, 2010, now abandoned.
(60) Provisional application No. 61/246,986, filed on Sep. 30, 2009.

(51) Int. Cl. H04R 1/02

(52) U.S. Cl. CPC H04R 1/02
USPC 381/333

(57) ABSTRACT

A waterproof speaker and audio system that can be worn in one or more holding pockets in a wetsuit, neoprene collar, or other garment, the waterproof speaker and audio system having one or more components. A first component may have one or more of the following: a transmitter unit, speaker, amplifier, digital audio file storage space (for example, MP3 or Windows Media Audio file), rechargeable battery, one or more buttons, one or more input and output ports such as a universal serial bus (USB) port for charging the battery and file transfer, one or more LED lights to indicate battery charge, a screen to provide audio file information including track number, and an FM and AM radio, and a second component designed to work in connection with the first component which may have one or more of the following: an amplifier, rechargeable battery, speaker, receiver, and one or more control buttons.

### CROSS-REFERENCES TO RELATED APPLICATIONS

This patent application is a continuation-in-part of U.S. patent application Ser. No. 12/883,099, filed Sep. 15, 2010, entitled “Waterproof Speakers and Audio System,” which claims the benefit of U.S. Provisional Patent Application Ser. No. 61/246,986 filed Sep. 18, 2009 for “A Waterproof Speaker System (with built in rechargeable batteries and amplification) located on or near any part of the body, supported in a holding pocket for speakers and Digital Transmitter,” which applications are incorporated in their entirety here by this reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to a waterproof speaker and audio system with one or more of the following: a transmitter, speakers, digital file memory storage device, converter to convert audio files into sound, rechargeable batteries, volume amplification, input and output capability, signal receiver, the system capable of being mounted on or near any part of the body in one or more holding pockets in a wetsuit, neoprene collar, or other garment.

### BACKGROUND ART

Engaging in water sports that require a wetsuit or other specialty apparel can be fun and exciting, but can be tedious or unstimulating without some sort of sound such as one's favorite music, broadcast, or other audio output. Access to audio output can be technically impossible in the water, physically uncomfortable, or difficult to hear with existing water-resistant or waterproof devices.

Many audio players available on the market have significant technical difficulties such as structural deficiencies that prevent the player from being secured to a person or garment while in the water, a sound system that does not transmit sound loud enough or well enough to be heard by the user, little or no battery power, and confusing external controls that incorrectly display battery charge, volume, and track number, or non-existent external control functions that leave a user guessing when the device will run out of battery or has a charged battery, what track the device is playing, or the volume level.

Also, in trying to keep the device compact, many players utilize the same button for multiple tasks, including powering on and off resulting in inadvertent powering down when trying to change audio files or increase or decrease volume.

Other waterproof cases for audio players that are not water resistant have significant drawbacks, including the inability to be totally sealed to prevent water from seeping in and difficulty in hearing the audio output

There exists a need in the art to provide an audio player system that can be utilized in the water, attached to a user, with a stable battery life, the battery being easily rechargeable, and designed with components to ease using the system.

### DISCLOSURE OF INVENTION

The present invention is directed to a waterproof speaker and audio system that can be worn in one or more holding pockets in a wetsuit, neoprene collar, or other garment. The waterproof speaker and audio system has one or more components, each component having one or more speakers and designed to work in conjunction with the other components within the system.

In one embodiment, the present invention has a first and second component. The first component or “master” component has one or more of the following: a speaker, digital audio file storage device (for example, capable of storing MP3 or Windows Media Audio files), converter to convert audio files into sound, rechargeable battery, one or more buttons, including buttons for volume control, audio file selection, and broadcast channel selection, one or more input or output ports such as a universal serial bus (USB) port for charging the battery and file transfer, one or more jacks to receive plugs, such as a ⅛ plug to connect the unit by hardwire to head phones or to the second component, a power input for a battery charger, one or more LED lights to indicate battery charge, a screen to provide audio file information including track number, transmitter, amplifier, FM and AM radio, and tsunami warning alert.

The ports may be capable of receiving a USB plug to charge the battery and file transfer. A jack may also be capable of receiving a plug such as a ⅛ plug. The port may also be a flip out USB port capable of being plugged into a computer for charging the battery and file transfer. In having one or more input or output ports, the first component may have different configurations; for example, the first component may have a USB flip out port capable of receiving a plug, a USB port capable of receiving a plug, a USB flip-out port and USB port, a USB flip out port, a USB port, or a port capable of receiving a plug. The flip-out USB port is tucked into the first or second component when closed and may include a release button to release it and move it into the flipped-out, open position. When the USB port is in the flipped-out open position, it can be plugged into another electronic device.

The first component may optionally include one or more of the following: a mobile phone signal receiver and built in mobile phone, a wireless receiver, such as Bluetooth for wireless connection to a mobile phone, an induction coil for wireless battery charging, and the like.

A second component designed to work in connection with the first component has one or more of the following: speaker, rechargeable battery, one or more buttons for volume control and volume control system, one or more LED lights to indicate volume level, receiver, amplifier, and jacks capable of receiving a plug, such as a ⅛ plug to connect the unit by hardwire to head phones or to the first component, power input to recharge the battery, USB port, and the like. To work in connection with each other, the first and second components may be capable of communicating wirelessly or via a hardwired connection. The first component and second component may work wirelessly together to emit audio through the speakers or if a wired connection is used, it can be inserted into the jacks of the first and second components and the wire can be discretely tucked into the apparel such as the wetsuit or collar used in connection with the inventive system.

The system is capable of being mounted on or near any part of the body in one or more holding pockets in a wetsuit, neoprene collar, or other garment. Preferably, the system is mounted in close proximity to a user's ears. In one embodiment, the system is capable of being mounted on the shoulders of a wetsuit. The shoulder mounts can be affixed to a wetsuit in a manner so that they are securely connected in wet environments. The inventive system can be inserted into the shoulder mounts and secured into the mount as a pressure fit or as a pocket with closure. Alternatively, the inventive system can be secured into a wetsuit manufactured with pocket inserts or it can be secured into other sports apparel in shoulder or arm pockets; for example, in biking, running, or walking apparel or in a life jacket, jacket, shirt, webbing, strapping, or netting top vest.

In yet another embodiment, the system is capable of being mounted in a neck collar with two or more pockets. In one embodiment, the collar has first and second pockets. The first and second pockets may be positioned on each side of the collar in parallel relation to each other in close proximity to the user's ears, just under the ears of a wearer. The collar is preferably made of neoprene or other waterproof material, floatable, and constructed with a reusable clasp that may release upon significant pressure in safety situations, including choking prevention. The clasp may be located in between the first and second pockets and may be positioned to be worn in the back of the neck or in the front. Additional pockets in the collar may be designed to carry electronic devices such as a cell phone or two-way radio, for example, a third pocket may carry the electronic device and may be positioned under a wearer's mouth to allow for an optimal position to capture the user's voice.

The inventive system is waterproof, meaning that it is capable of resisting water and capable of emitting audio and receiving and transmitting signals in wet environments. The system may resist water in various depths, for example, in depths up to 50 feet.

In another embodiment, the speakers in the one or more components can be in different configurations; for example, the first component may have one or more speakers and the second component may have one or more speakers.

The rechargeable battery in the first and second components can be recharged wirelessly or via the one or more ports on the first component or the one or more ports on the second component.

The speakers may be capable of different amperages in order to emit enough volume to be heard in wet, windy, dirty, and otherwise rough physical conditions. The inventive first and second components with speakers are worn close to the ear, but not in the ear thus creating a very safe environment for the user who is capable of hearing other noises when listening to the audio output. This allows the user to be aware of the environment, including approaching large waves, wildlife, seacraft, and other people. The waterproof feature of the first and second component is ideal for water use and sports use where one may be exercising and perspiring or exercising in rainy, wet conditions.

Also, mounting the first and second components on the shoulders or in a collar provides for waterproof hands free and hassle free listening.

In use, a digital signal can be transmitted to the first component via wire or wireless transmission, the first component can receive the signal with a receiver, amplify them with the amplifier and direct the sound out through the speaker pointed in the direction of the ear. The second component can receive the signal as well and amplify it, and direct the sound out through the speaker so that both components have sound coming out of the speakers.

The components of the system are of a size and shape that allows the waterproof speaker and audio system to be mounted on the shoulders or the neck of a user and still allow maximum mobility while engaging in sports related activities such as surfing, paddle boarding, biking, running, swimming, and the like. In one embodiment, the components are from 1.5 to 3.0 inches wide, 0.5 to 1.5 inches high, and 0.2 to 1.0 inch thick. In another embodiment, the components are about 2.5 inches wide, 1.0 inch high, and 0.5 inch thick.

### BRIEF DESCRIPTION OF DRAWINGS

FIG. 1 is a front view of one embodiment of the waterproof speaker and audio system having two components.

FIG. 2 is a perspective view of one embodiment of the waterproof speaker and audio system having two components as shown in FIG. 1.

FIG. 3 is a front view of one embodiment of the waterproof speaker and audio system having two components and having a flip-out USB plug.

FIG. 4 is a perspective view of one embodiment of the waterproof speaker and audio system having two components and having a flip-out USB plug as shown in FIG. 3.

FIG. 5 is a front view of the waterproof speaker and audio system in use mounted in two shoulder pockets in a wetsuit.

FIG. 6 is an expanded view of shoulder mounts for attaching the mounts to a wetsuit, the mounts capable of receiving the waterproof speaker and audio system.

FIG. 7 is a front view of a waterproof collar adapted to be used with the waterproof speaker and audio system.

FIG. 8 is a front view of the waterproof speaker and audio system in use mounted in two pockets in a collar as shown in FIG. 7.

FIG. 9 is a perspective view of another embodiment of the waterproof speaker and audio system.

FIG. 10 is a perspective view of another embodiment of the waterproof speaker and audio system.

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

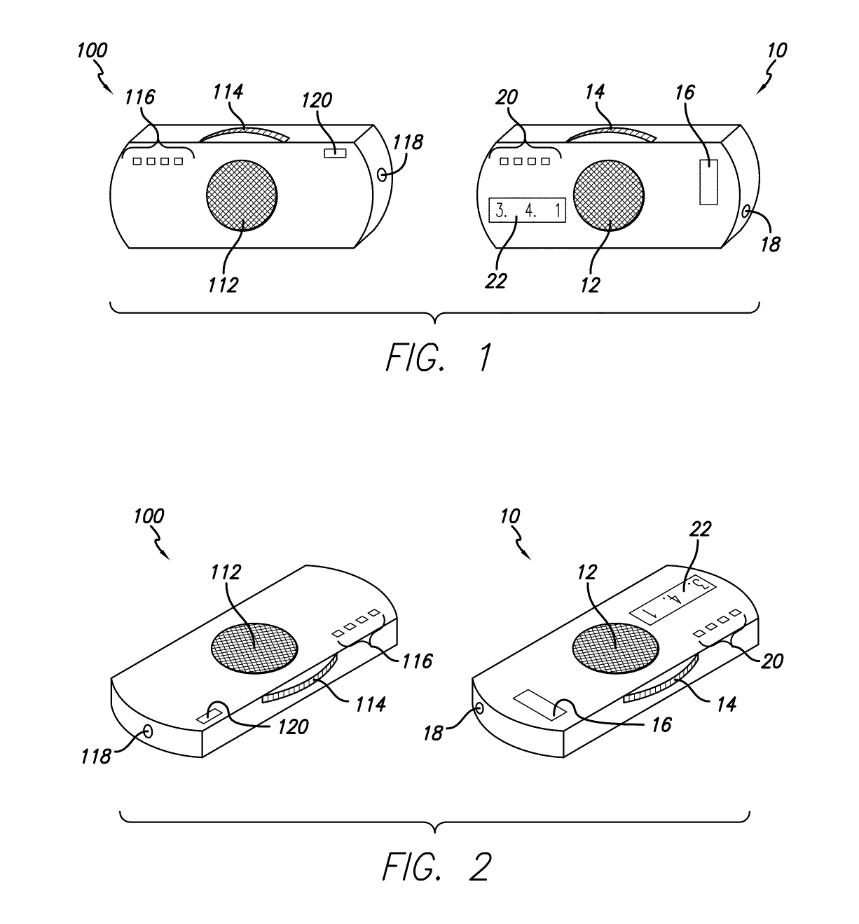

FIG. 1 depicts a front view of one embodiment of the waterproof speaker and audio system having a first and second component. The first component 10 has one or more of the following: a speaker 12, digital audio file storage device (for example, capable of storing MP3 or Windows Media Audio files), converter to convert audio files into sound, and rechargeable battery (all of which are inside the component and not shown), a button 14, a USB port 16, a power input capable of receiving a plug, such plug for charging the battery, and/or a jack 18 for connecting to external devices such as headphones or connecting the first component 10 to the second component 100. The first component also has one or more indicator lights 20 to indicate battery charge, a screen 22 to provide audio file information including track number, and transmitter, amplifier, FM and AM radio, and tsunami warning alert (all of which are inside the component and not shown). The button 14 may be for volume control, audio file selection, and/or broadcast channel selection.

The first component may optionally include one or more of the following: a mobile phone signal receiver and built in mobile phone, a wireless receiver, such as Bluetooth, and an induction coil for wireless battery charging.

A second component 100 designed to work in connection with the first component 10 is also shown. The second component 100 has one or more of the following: speaker 112, one or more buttons 114 for volume control and volume control system, one of which is shown, one or more indicator lights 116 to indicate volume level, receiver, amplifier, and rechargeable battery (all of which are inside the component and not shown), and one or more jacks 118 or input/output ports 120 capable of receiving a plug. For example, a plug such as a ⅛ plug to connect the unit by hardwire to head phones or to the first component or a power input to recharge the battery or a USB port 120 for power and data transfer. The port 120 may be located on the front of the second component 100 as shown or it may be on the side or back of the second component.

The indicator lights 116 may be LED or any other light source that uses very little energy to emit light and can be used in a waterproof system.

FIG. 2 provides a perspective view of one embodiment of the waterproof speaker and audio system having two components as shown in FIG. 1. The external elements of the first and second components (10 and 100, respectively) are shown. For example, the first component 10 has a speaker 12, screen 22, button 14, input and/or output ports 16, jacks 18, and indicator lights 20. The second component 100 has a speaker 112, button 114, input and/or output ports 120, jacks 118, and indicator lights 116.

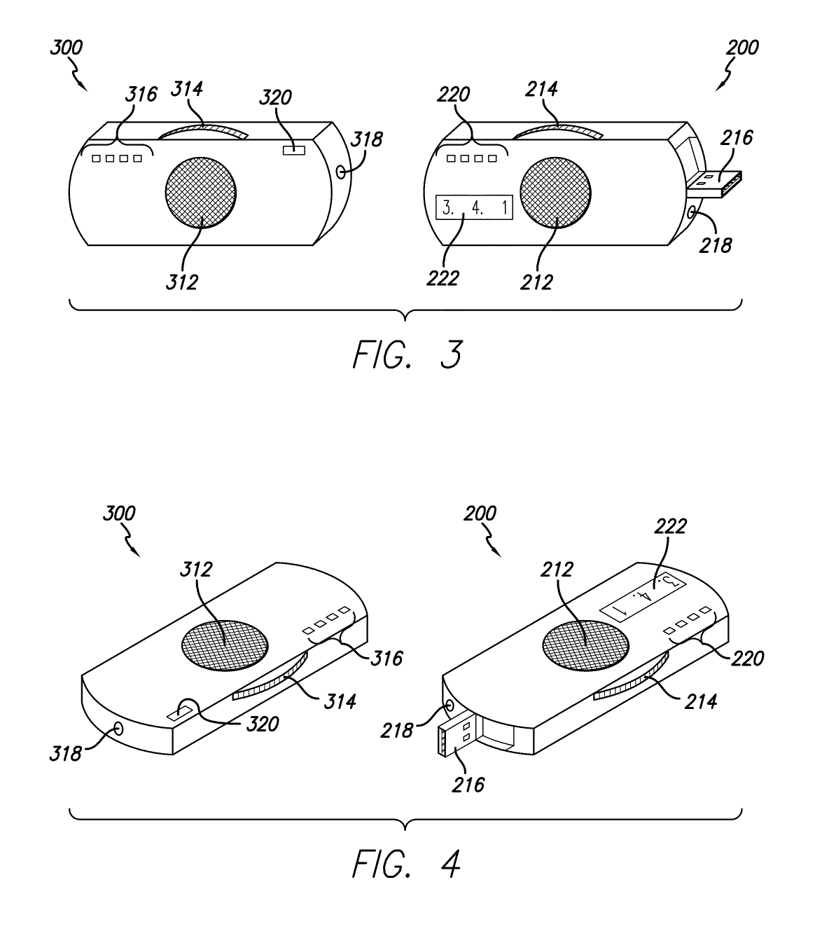

FIG. 3 depicts a front view of one embodiment of the waterproof speaker and audio system having a first and second components, 200 and 300, respectively, and having a flip-out USB port 216. As shown, the first component 200 has indicator lights 220, a flip-out USB port 216, a jack 218, a screen 222, and a speaker 212. It is understood that the first component 200 has internal elements not shown in order to make the component operable as an audio system, including a digital audio file storage device (for example, capable of storing MP3 or Windows Media Audio files), converter to convert audio files into sound, rechargeable battery, transmitter, amplifier, FM and AM radio, and tsunami warning alert. Also, the second component 300 of the waterproof speaker and audio system is shown. The second component 300 has a speaker 312, indicator lights 316, a control button 314, and one or more input or output ports 320, and jacks 318. It is understood that the second component 300 has internal elements not shown in order to make the component operable as an audio system, including rechargeable battery, volume control system, receiver, and amplifier.

FIG. 4 depicts a perspective view of one embodiment of the waterproof speaker and audio system having first and second components 200 and 300, respectively and having a pop-out USB plug 216 as shown in FIG. 3. As shown, the first component 200 has indicator lights 220, a flip-out USB plug 216, an input port 218, a screen 222, and a speaker 212. It is understood that the first component 200 has internal elements not shown in order to make the component operable as an audio system including but not limited to a digital audio file storage device (for example, capable of storing MP3 or Windows Media Audio files), converter to convert audio files into sound, rechargeable battery, transmitter, amplifier, FM and AM radio, and tsunami warning alert. Also, the second component 300 of the waterproof speaker and audio system is shown. The second component 300 has a speaker 312, indicator lights 316, a control button 314, and one or more jacks 318 and 320. It is understood that the second component 300 has internal elements not shown in order to make the component operable as an audio system, including but not limited to rechargeable battery, volume control system, receiver, and amplifier.

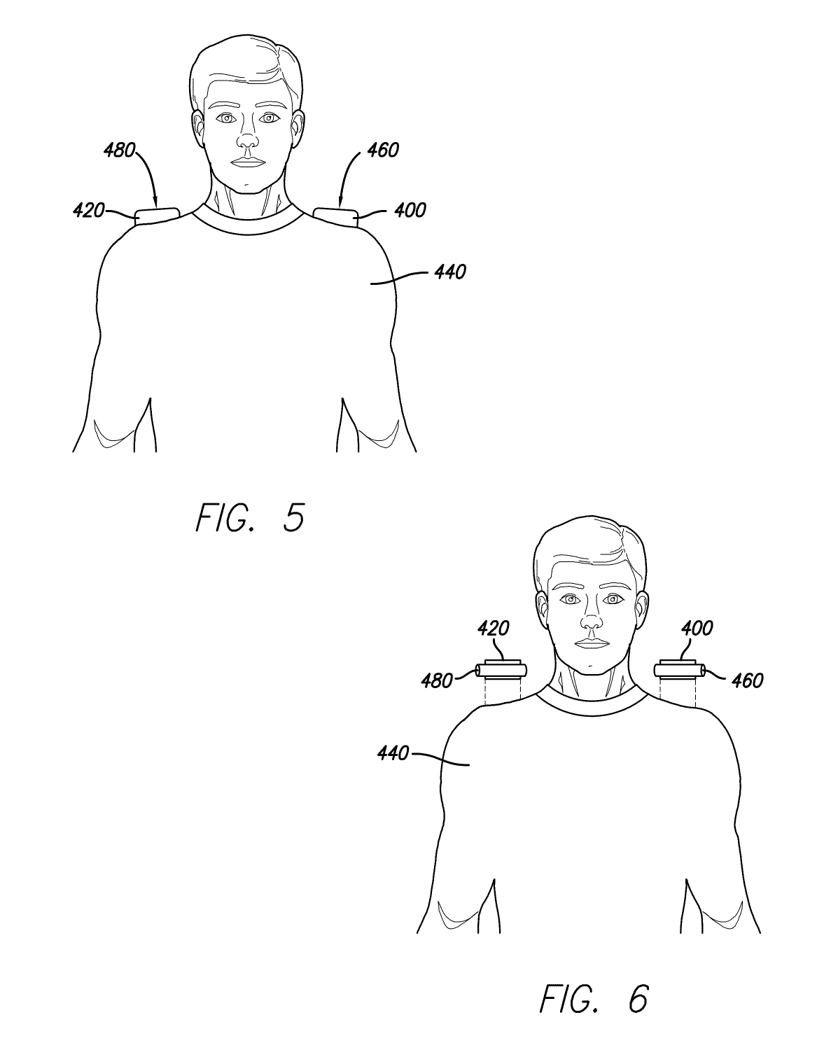

FIG. 5 depicts a front view of the waterproof speaker and audio system 460 and 480 in use mounted on two shoulder pockets 400 and 420 in a wetsuit 440. The may be mounted on or near any part of the body in one or more holding pockets in a wetsuit, neoprene collar, or other garment. Preferably, the system is mounted in close proximity to a user's ears. As shown, the system is capable of being mounted on the shoulders of a wetsuit 400. The shoulder mounts 400 and 420 can be affixed to a wetsuit 440 in a manner so that they are securely connected in wet environments. The inventive system 460 and 480 can be inserted into the shoulder mounts and secured into the mount as a pressure fit or as a pocket with closure. Alternatively, the inventive system can be secured into a wetsuit manufactured with pocket inserts or it can be secured into other sports apparel in shoulder or arm pockets; for example, in biking, running, or walking apparel or in a life jacket, jacket, shirt, webbing, strapping, or netting top vest.

FIG. 6 provides an expanded view of shoulder mounts 400 and 420 for attaching the mounts 400 and 420 to a wetsuit 440. The mounts 400 and 420 are capable of receiving the waterproof speaker and audio system 460 and 480. The mounts 400 and 420 can be sold as aftermarket, attachable pockets that a user can install onto his wetsuit 440. The mounts 400 and 420 can be attached by any means capable of securing them to a wetsuit 440 and staying secured in wet or rough environments. Alternatively, the mounts 400 and 420 can be attached when a wetsuit 440 is manufactured. The mounts 400 and 420 are of a size and shape capable of receiving the waterproof speaker and audio system 460 and 480. They may be designed with an opening on one side so that the speakers of the one or more inventive components are not covered. The opening may be of a shape and size capable of allowing audio to be transferred through.

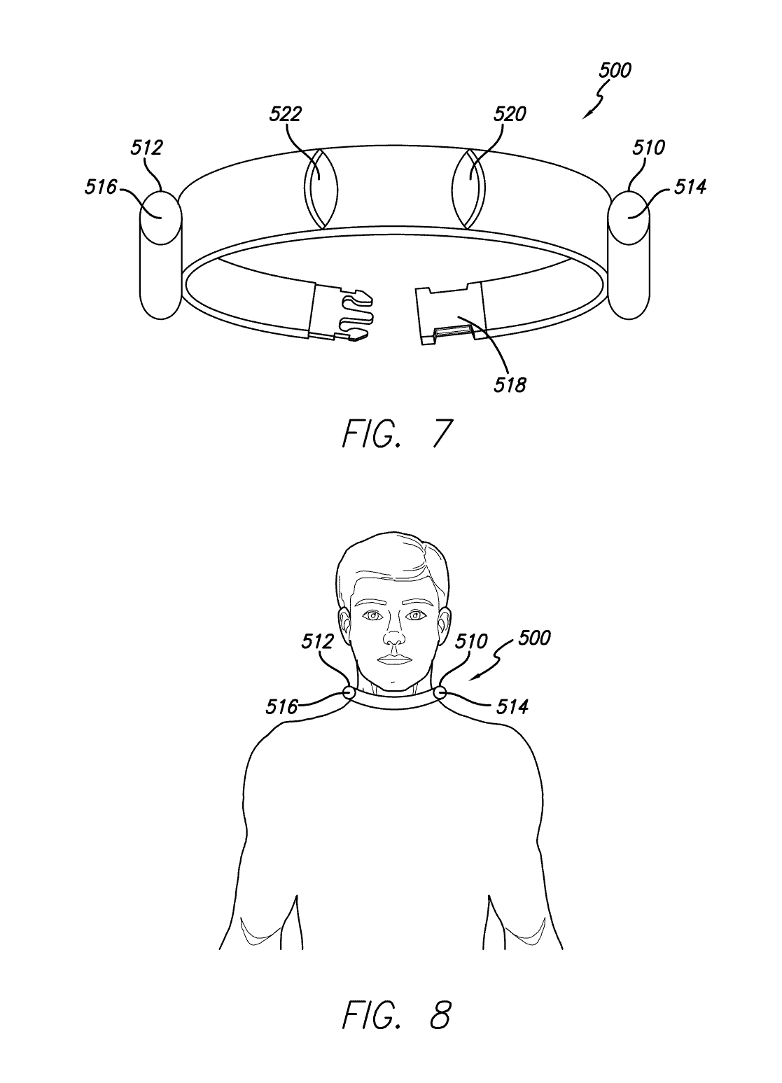

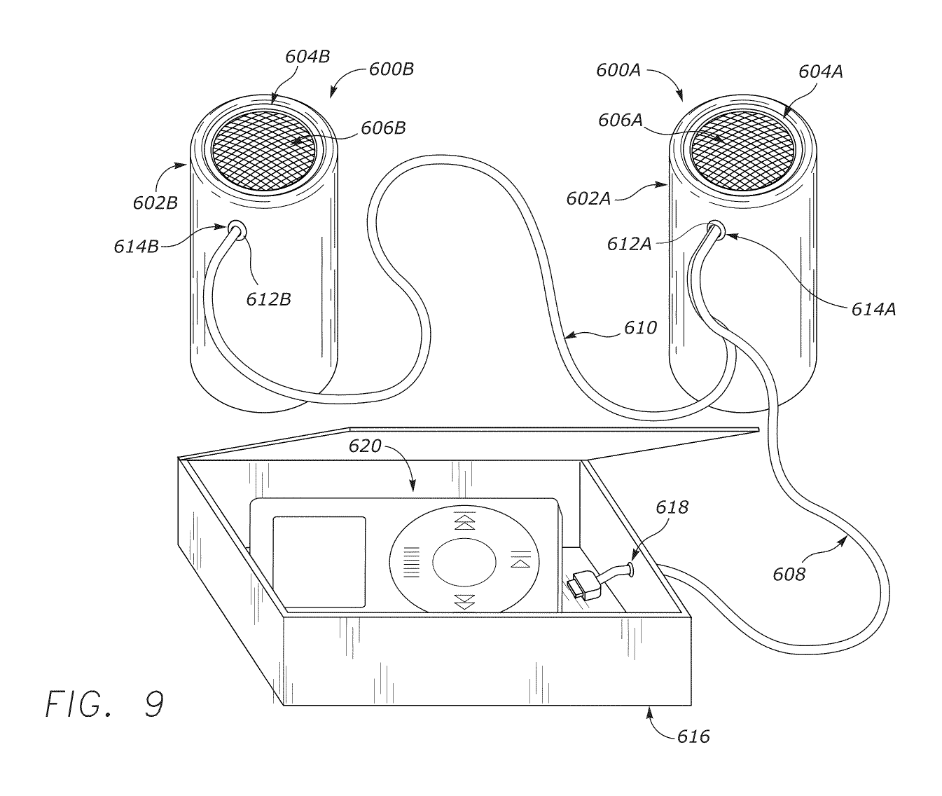

FIG. 7 depicts a front view of another embodiment of the waterproof speaker and audio system having a waterproof collar 500 adapted to be used with the first and second components 514 and 516, which are essentially the same as the first component 10 or 200 and second components 100 or 300, respectively, described in the previous embodiments. As shown, the collar 500 has first and second pockets 510 and 512, respectively. The first and second pockets 510 and 512 may be positioned on opposite sides of the collar 500 in parallel relation to each other and in close proximity to the user's ears when worn, for example, just under the ears of a wearer as shown in FIG. 8. The first and second pockets 510 and 512 can be fastened to the collar by any known means such as stitching, hook-and-loop fasteners, button, and the like. The collar 500 is preferably made of neoprene or other waterproof material, floatable, and constructed with a releasable clasp 518 that may release upon significant pressure in safety situations, including a choking prevention mechanism. For example, in some embodiments, for the choking prevention mechanism, the clasp 518 may be a modified snap buckle in which a portion of the male buckle that abuts and locks against the female receiver may be slightly tapered, such that a threshold force pulling the male buckle away from the female receiver causes the male buckle to slip out of the female receiver without breaking the buckle.

The clasp 518 may be located in between the first and second pockets 510 and 512 and may be positioned to be worn in the back of the neck or in the front. A neoprene shell may envelope a floatable core, such as a foam core. Additional pockets 520 and 522 in the collar 500 may be designed to carry electronic devices such as a cell phone or two-way radio, for example. The additional pockets 520 and 522 pocket may carry the electronic device and may be positioned under a wearer's mouth to allow for an optimal position to capture the user's voice. In some embodiments, the cell phone or radio may transmit to the speaker and audio system 514 and 516 wirelessly or through a wired connection.

FIG. 8 shows a front view of the waterproof speaker and audio system 514 and 516 in use mounted in two pockets 510 and 512 in the collar 500 shown in FIG. 7.

In another embodiment, a waterproof speaker 600A may be separate and apart from the components 10, 100, 200, or 300 but operatively connected to the component, for example, wirelessly or through a wire. The waterproof speaker 600A comprises a housing 602A, a diaphragm 606A contained in the housing 602A, and a water tight seal 604A to prevent any moisture from entering into the housing 602A passed the diaphragm 606A. The waterproof speaker 600A may also contain all required parts for a speaker, such as a spider, basket, terminals, top plate, voice coil, core, magnet, and/or back plate.

The housing 602A may be constructed of a waterproof material, such a plexiglass, or other type of plastic. In the preferred embodiment, the housing 602A is cylindrical in shape defined by a circular or cylindrical outer wall with a main cavity defined by an inner wall, preferably circular in shape. The typical speaker parts are housed inside the cavity and contained by the diaphragm 606A. The diaphragm 606A, also preferably circular in shape, has a dimension (e.g. the diameter of the diaphragm) substantially similar to the dimension of the inner wall (e.g. the diameter of the inner wall). Thus, when the diaphragm 606A is inserted into the cavity, the diaphragm essentially closes the opening to the cavity creating a tight seal to prevent any water from entering into the cavity, thereby keeping other components of the speaker 600A dry. The diaphragm may be secured to the housing with a water tight seal 604A around the perimeter of the diaphragm to facilitate the waterproof seal. This allows the speaker 600A to be waterproof without diminishing the sound quality.

The diaphragm 606A is made of waterproof or water resistant material that is known in the art for making waterproof diaphragms. The watertight seal 604A may be made of a waterproof material, such as rubber, polyvinyl chloride, polyurethane, and silicone elastomer. The watertight seal 604A can further be made using a gasket or other adhesive. The remaining speaker components are fully enclosed within plexiglass housing 602A and sealed from the external environment by the diaphragm 606A.

A first audio cable 608 connects the terminals of a player 620, such as a multimedia player, phone, radio, and the like, which may be encased within a waterproof player housing 616, to the terminals of the speaker 600A through an auxiliary hole 614A in the housing 602A. Silicone 612A or other waterproof sealant may be used to close and fill any gaps between the exterior of the audio cable 608 and the plexiglass 602A at the auxiliary hole 614A. Silicone is also used to fill any gaps between the watertight seal 604A and the plexiglass housing 602A, thus ensuring no water will enter into the internal components. The housing 602A may also contain an amplifier to amplify the sound signals for the speaker 600A.

In another embodiment there may be two waterproof speakers 600A and 600B which may be separate and apart from the components 10, 100, 200, 300. Waterproof speaker 600B may be essentially the same as waterproof speaker 600A. Therefore, waterproof speaker 600B may contain all the same required parts for a speaker as discussed for speaker 600A, such as watertight seal 604B, diaphragm 606B, spider, basket, terminals, top plate, voice coil, core, magnet, and/or back plate contained in a housing 602B that is similar to the housing 602A. Therefore, speaker 600B maintains the waterproofing feature in the same way as speaker 600A. A second audio cable 610 may connect the terminals of the first speaker 600A to the terminals of the second speaker 600B for audio input to second speaker 600B. A waterproof sealant, such as silicone 612B is used to close and fill any gaps between the exterior of the audio cables 610 and the plexiglass 602B. The waterproof sealant is also used to fill any gaps between the watertight seal 604B and the plexiglass housing 602B, thus ensuring no water will enter into the internal components. Speaker 600B may also contain an amplifier to amplify sound signals being produced.

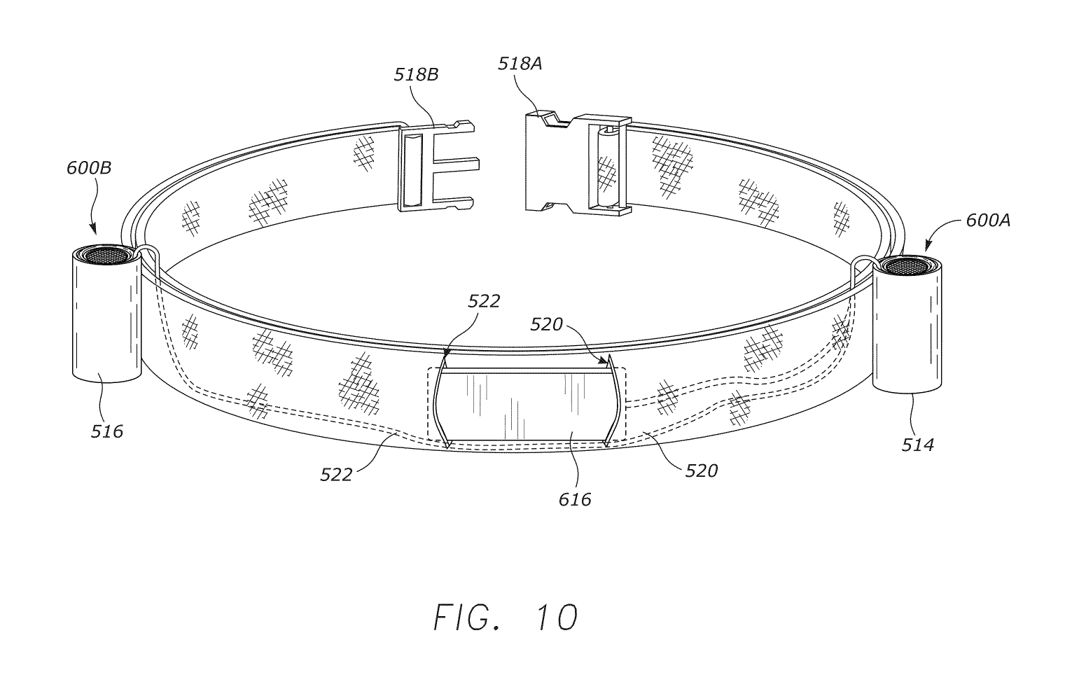

The waterproof speakers 600A and 600B each fit into the collar 500 which has been adapted to be used with the first speaker 600A and the second speaker 600B. In particular, the collar 500 has at least one pocket 510, and preferably, two pockets 510 and 512 to house waterproof speakers 600A and 600B. The pockets 510 and 512 may be positioned on opposite sides of the collar 500 in parallel relation to each other and in close proximity to the user's ears when worn. The waterproof speakers 600A and 600B may be inserted into the first and second pockets 510 and 512, respectively, so they may be heard by the user when played. In some embodiments, the pockets 510 and 512 may be configured so that the diaphragms 606A and 606B point upwardly towards the wearer's ear when the collar is worn properly as shown in FIG. 10. In some embodiments, the pockets 510 and 512 may be adjustable so that the speakers 600A and 600B can point in any desired direction. For example, the pockets 510 and 512 may be fixed to the collar 500 using a swiveling device. The collar 500 may be hollow or double layered so that the cable from one speaker 600A to the other speaker 600B can be contained within the collar 500 to avoid any loose wiring.

The collar 500 may have an additional holder. The additional holder may be another pocket like pockets 510 and 512. In some embodiments, the additional holder may simply be slits 520 and 522. The slits 520 and 522 may be designed within the collar 500 to carry waterproof electronic devices that play through the speakers 600A and 600B, such as cell phone, or two-way radio, or waterproof player housing 616 containing an electronic device, 620, and the like. Since the collar 500 is preferably made of an elastic material, the electronic device 620 or waterproof housing 616 can be inserted through one slit 522 behind the collar 500 and then out the other slit 520. The electronic device can be hard wired to speaker 600A and/or 600B. In some embodiments, the speakers may have a wireless receiver and the electronic device a wireless transmitter so that the audio data can be transferred from the electronic device 620 to the speakers 600A and/or 600B wirelessly.

The collar 500 may have a defined internal channel between the layers of collar material that spans the length between the pockets 510 and 512 or other slits 520. The internal channel is wide enough to provide the ability to connect the pockets 510 and 512 or other slits 520 together so that, for example, the second audio wire 610 can be enclosed within the internal channel to connect the first waterproof speaker 600A and the second waterproof speaker 600B while not being visible outside of the collar 500. In another preferred embodiment the pockets 510 and 512, other slits 520, additional holders, and internal channel can be made of a waterproof material such as rubber, polyvinyl chloride, polyurethane, or silicone elastomer so that no water is able to enter permeate them. Using a waterproof material for the pockets, slits, or internal channel allows for non-waterproof components to be used, such as non-waterproof speakers or wires.

Furthermore, the collar 500 maintains a releasable clasp with a choking prevention mechanism that allows for the immediate release of the collar 500 from the wearer's neck if a sufficient amount of pressure to cause choking is placed upon the clasp or collar 500. In other words, once a sufficient amount of pressure is placed upon the clasp or collar 500 the clasp is to quickly release and separate from itself thus opening the collar 500 and allowing the collar 500 to fall from the wearer's neck.

While the present invention has been described with regards to particular embodiments, it is recognized that additional variations of the present invention may be devised without departing from the inventive concept.

### INDUSTRIAL APPLICABILITY

This invention may be industrially applied to the development, manufacture, and use of a waterproof speaker and audio system.

What is claimed is:

1. A waterproof speaker and audio system, comprising:
(a) a component for storing and playing audio files;
(b) a first speaker, operatively connected to the component, the first speaker comprising a first waterproof diaphragm enclosed within a first waterproof housing;
(c) a second speaker comprising a second waterproof diaphragm enclosed within a second waterproof housing operatively connected to the first speaker;
(d) a first audio cable connecting the component to a terminal of the first waterproof speaker;
(e) a second audio cable connecting the terminal of the first speaker to a terminal of the second speaker; and
(f) a collar with first and second pockets, the first pocket for holding the first speaker and the second pocket for holding the second speaker, wherein the collar can be worn about a user's neck so that the first and second components are proximal to the user's ears.

2. The waterproof speaker and audio system of claim 1 wherein the collar has an additional holder for holding the component.

3. The waterproof speaker and audio system of claim 1 wherein the collar is made of neoprene defining an internal channel.

4. The waterproof speaker and audio system of claim 1 wherein the collar has a releasable clasp having a choking prevention mechanism.

5. The waterproof speaker and audio system of claim 4 wherein the first and second pockets are in parallel relation in close proximity to the user's ears and the clasp is located in between the first and second pockets.

6. A speaker and audio system, comprising:
(a) a first component;
(b) a second component; and
(c) a collar with first and second pockets, the first pocket for holding the first component and the second pocket for holding the second component,
(d) wherein the collar can be worn about a user's neck so that the first and second components are proximal to the user's ears.

7. The speaker and audio system of claim 6 wherein the collar has an additional holder capable of holding at least one component.

8. The speaker and audio system of claim 6 wherein the collar is made of neoprene defining an internal channel.

9. The speaker and audio system of claim 6 wherein the collar has a releasable clasp having a choking prevention mechanism.

10. The waterproof speaker and audio system of claim 9 wherein the first and second pockets are on opposite sides and in parallel relation to each other, and in proximity to the user's ears and the clasp is located in between the first and second pockets.

11. The waterproof speaker and audio system of claim 6 wherein the first pocket and the second pocket are made of a waterproof material.

12. A speaker and audio system comprising:
(a) a collar with at least one pocket; and
(b) a speaker housed within at least one pocket,
(c) wherein said collar can be worn about a user's neck so that said pocket is proximal to at least one of the user's ears.

13. The speaker and audio system as in claim 12 wherein said collar is made of neoprene defining an internal channel

14. The speaker and audio system as in claim 12 wherein said collar has a releasable clasp having a choking prevention mechanism.

15. The speaker and audio system as in claim 12 wherein said collar further comprises an additional holder for holding a device.

16. The speaker and audio system of claim 12 further comprising collar with at least two pockets.

17. The speaker and audio system of claim 16 wherein the collar can be worn about the user's neck so that the pockets are proximal to the user's ears.

18. The speaker and audio system of claim 16 wherein a first pocket and a second pocket are in parallel relation in close proximity to the user's ears and the clasp is located in between the first and second pockets.
